(19) United States
(12) Patent Application Publication
(10) Pub. No.: US 2008/0077726 A1
(43) Pub. Date: Mar. 27, 2008

(54) Computer remote control module, interface, system and method

(76) Inventor: David W. Gilbert, Shackleford (GB)

Correspondence Address: George R. Schultz;Schultz & Associates, P.C., One Lincoln Centre, 5400 LBJ Freeway, Suite 1200, Dallas, TX, 75240, US

(21) Appl. No.: 11/899,858

(22) Filed: Sep. 7, 2007

Related U.S. Application Data
(60) Provisional application No. 60/843,285, filed on Sep. 7, 2006.

(51) Int. Cl. G06F 13/00

(52) U.S. Cl. 710/316

(57) ABSTRACT

A freestanding remote functionality module 100 for a computer is provided, the module comprising a hardware control switch 110 for receiving user input 120 regarding a desired hardware state of the computer, and a communicating device 150 coupled to the switch 110 to a receive hardware control signal 114 from the switch 110 and transmit said hardware control signal 114a to an interface mounted on the computer to control the hardware of the computer.

### CROSS-REFERENCE TO RELATED APPLICATIONS

This application claims priority to U.S. Provisional Application No. 60/843,285, entitled “Computer Remote Control Module, Interface, System and Method,” filed Sep. 7, 2006.

### FIELD OF THE INVENTION

The present invention relates to modules to provide functionality for a computer, to interfaces to interface between such a module and such a computer, and to methods and systems relating to such modules and interfaces.

### BACKGROUND

Personal computers are widely used in both the office and home. Such personal computers may be situated on the desktop, or placed below the desk. Personal computers generally include mass data storage readers, such as CD readers, DVD readers, smart card readers, and/or memory card readers. Further, USB ports are also generally provided, which may connect the computer to one or more peripheral devices, such as CD readers, keyboard or mouse devices. A power button is provided, together with indicator lights providing an indication of the status of the personal computer and a built in hard disc drive within the personal computer.

The present invention seeks to overcome or ameliorate at least one problem associated with the prior art.

### SUMMARY OF INVENTION

According to an aspect of the invention, there is provided a remote control module for a computer. In an aspect, the computer is a personal computer. In an aspect, the module is freestanding and/or mobile. In an aspect, the module is adapted to control at least one hardware function of the computer remotely. In an aspect, the module is adapted to control the power state of the computer, and in an aspect the module comprises a remote on/off switch. In an aspect, a user operable power control switch is provided. In an aspect, a freestanding remote computer control module is provided.

In an aspect of the invention, the module includes data receiving means. In an aspect, the data receiving means is a mass data storage reading means. In an aspect of the invention, the data receiving means is chosen from DVD, DVD+R, DVD+R(W), CD, CDR, CDRW, USB, smart card reader, skype (RTM), firewire (RTM), audio in, blu-ray and HD DVD. More than one data receiving means may be provided. Further, in an aspect data output means are also provided. The data output means may include audio out, CDR, CDRW, DVD+R, DVD+RW, Blu-ray, skype, (RTM) firewire (RTM). The data receiving means and output means may include the same device.

In an aspect of the invention, indicating means are provided, which provide an indication of an operating state of the computer. In an aspect, an indicator shows the power state of the computer. In an aspect, an indicator shows an active state of a Hard Disc Drive (HDD) of the computer. In an aspect of the invention, the indicators are LEDs. In an aspect, the indicators are chosen from a sound indicator, and a physically moving part or parts. Another aspect includes LCD displays and plasma displays.

In an aspect of the invention, communication means is provided. In an aspect, the communication means are configured to connect at least some of the features of the module to an interface coupleable to the computer. In an aspect, the communication means is for receiving a signal from the power switch based on user input and transmitting the signal to an interface to control the power state of the computer. In an aspect, the communication means is for receiving non-computer code signals from the switch. In an aspect, the communication means is for transmitting data read from the mass data storage reading means to the computer. In an aspect, the communication means is for receiving data to be written to the mass data storage and the reader is also a writer to the mass data storage. In an aspect, the communication means is for receiving one or more signals representative of at least one operating state of the computer and output the one or more signals to the at least one indication means

In an aspect, the communication means comprises one or more cables. In an aspect, the communication means comprises one or more wireless connections.

According to an aspect of the invention, an interface for connection of a computer with a freestanding remote functionality module of the computer is provided. In an aspect, a connector is provided to connect directly to two pins on a motherboard of the computer, electrical connection of the pins being required to provide power to the motherboard.

In aspects of the invention, the power to the computer can be turned on by the interface, on receiving control from the module, even when the computer is not in standby mode, but the computer is completely powered down. A ‘hard’, or ‘cold’ start up of the computer can be effected. In aspects of the invention, the interface is built in to the motherboard of the computer. In an aspect, the built-in interface includes a control to selectively provide power to the motherboard of the computer.

In an aspect, the connector is coupled to interface communication means to receive a signal from a remote module according to aspects of the invention, the signals indicating a desired power state of the computer. In an embodiment, one or more connectors are provided, which are coupled to interface communication means for receiving one or more signals representative of at least one operating state of the computer and transmitting the one or more signals to the remote module for output of an indicator signal at the remote module. In an aspect, interface communication means are provided for receiving computer readable data from the remote module and providing the computer readable data to the computer. In an aspect, interface communication means is provided for receiving computer readable data from the computer and transmitting the data to the remote module.

In an aspect of the invention, the interface communication means comprises one or more cables. In an aspect, the interface communication means comprises one or more wireless connections. In an aspect of the invention, the wireless connection is ultra-wide USB, which allows a data flow rate of up to 1 Gbit/sec and operates on high bandwidth, low power, radio frequency transmission. Alternatively, other wireless communication protocols and devices may be utilised in the device.

According to an aspect of the invention, a module according to an aspect of the invention is connected to an interface according to an aspect of the invention. In an aspect, an interface according to an aspect of the invention is coupled to a computer.

In aspects of the invention, the module includes the computer keyboard and/or mouse, or other peripheral device. In aspects, the peripheral device signals to and from the computer are sent through the communication means within the module and interface. The peripheral device may be connected to the computer via a USB port internal to the module, the signal from the USB port being transmitted to the interface and to the computer from the interface.

In aspects of the invention, the module also incorporates a display device of the computer. In aspects the monitor receives signals from the computer via the communication means in the module and interface. In embodiments, the interface includes a graphics card interface to receive graphics signals from a graphics card in the computer and transmit those signals to the module, via the interface communication means, and the module includes a monitor connector for receiving the monitor signals, via the communication means, and passing them to the monitor within the module to control the output of the monitor. In one aspect, the interface and module communication means include a cable to transmit the graphics signals to the module from the graphic card. In aspects, the module may be mounted to a wall, or otherwise.

According to an aspect of the invention, there is provided a freestanding remote computer functionality module, the module comprising a user operable power control switch configured to receive a user input regarding a desired power state of the computer and output non-computer code signal, and a communicating device coupled to the switch to receive the signal from the switch and transmit said signal to an interface mounted on the computer to control the power state of the computer.

According to an aspect of the invention, there is provided a freestanding remote computer functionality module for the module comprising at least one mass data storage reader, coupled to read computer readable data from mass data storage media, a user operable hardware control switch, configured to receive a user input regarding a desired state of the computer and output a signal, a first communicating device section coupled to the switch to transmit signals received from the switch to an interface to control the power state of the computer, and a second communicating device section coupled to at least one mass data storage reader to transmit data read from the mass data storage reader to the computer.

According to an aspect of the invention, there is provided a freestanding remote computer functionality module, the module comprising a user operable power control switch configured to receive power control input from a user of the computer, at least one indicator, provided to indicate the state of at least one operating state of the computer, at least one communicating device coupled to the switch to receive a signal from the switch and transmit the signal to the computer to control the power state thereof, and coupled to the indicator to receive one or more signals representative of at least one operating parameter of the computer and output the one or more signals to the at least one indicator.

According to an aspect of the invention, there is provided an interface for connection of a computer with a freestanding remote functionality module of the computer, the interface comprising an interface communicating device for receiving non-computer code signals received relating to a user input to control the power state of the computer, and a power controller coupled to the interface communicating device, adapted to directly connect to a motherboard of the computer, and to control the power state of the computer directly through the motherboard in response to the received signals.

According to an aspect of the invention, there is provided an interface for connection of a computer with a freestanding remote functionality module of the computer, the interface comprising an interface communicating device coupled to the computer, and adapted to receive computer readable data from the remote module and provide the computer readable data to the computer, and to receive signals relating to a user input from a remote user operable switch to control the power state of the computer, and a power controller coupled to the interface communicating device and adapted to directly connect to a motherboard of the computer and control the power state of the computer directly through the motherboard in response to the received user input signals.

According to an aspect of the invention, there is provided A remote computer control system, comprising a freestanding remote computer functionality module and an interface adapted to connect the computer with the freestanding remote functionality module for a computer. The module comprises a user operable power control switch configured to receive a user input regarding a desired power state of the computer and output a non-computer code signal, and a communicating device coupled to the switch to receive the signal from the switch and transmit the signal to an interface mounted on the computer to control the power state of the computer. The interface comprises an interface communicating device adapted to receive non-computer code signals received relating to a user input to control the power state of the computer, and a power controller coupled to the interface communicating device, adapted to directly connect to a motherboard of the computer and control the power state of the computer directly through the motherboard in response to the received signals.

According to an aspect of the invention, there is provided a freestanding remote computer functionality module, the module comprising at least one mass data storage reader, mounted in the module, a first wireless com module coupled to the data reader to transmit data read from the at least one mass data storage reader from the module to the computer, a remote power control switch a remote power indicator, a second wireless communicating device mounted in the module coupled to the remote power control switch and remote power indicator, to transmit instructions to the computer to control the motherboard of the computer directly based on user activation of the remote power control switch and to receive signals from the computer indicative of a power state of the computer.

According to a further aspect of the invention, there is provided a freestanding remote computer functionality module, the module comprising at least one mass data storage reader, a remote power control switch, and a remote power indicator, mounted in the module, a cable socket coupled to the at least one mass data storage reader, the remote power control switch and the remote power indicator, the cable socket being adapted to receive a cable connected to the computer, to transmit from the cable socket data read from the at least one mass data storage reader and instructions to the computer to control the motherboard of the computer based on user activation of the remote power control switch, and to receive into the cable socket, and receive signals from the computer indicative of a power state of the computer.

### BRIEF DESCRIPTION OF THE DRAWINGS

Embodiments of the invention will now be described, purely by way of example, with reference to accompanying drawings, in which:

FIGS. 1-3 show freestanding remote functionality modules according to embodiments of the invention;

FIGS. 4 and 5 show remote computer control interfaces according to embodiments of the invention;

FIG. 6 shows a remote computer control system according to an embodiment of the invention;

FIG. 7 shows a method of operation of the system of FIG. 6;

FIG. 8A shows a freestanding remote functionality module according to a further embodiment of the invention;

FIG. 8B shows a freestanding remote functionality module according to a further embodiment of the invention;

FIG. 9A shows a remote computer control interface according to a further embodiment of the invention;

FIG. 9B shows a remote computer control interface according to a further embodiment of the invention;

FIG. 10 shows a freestanding remote functionality module according to a further embodiment of the invention; and

FIG. 11 shows a remote computer control interface according to a further embodiment of the invention.

### DETAILED DESCRIPTION OF EMBODIMENTS OF THE INVENTION

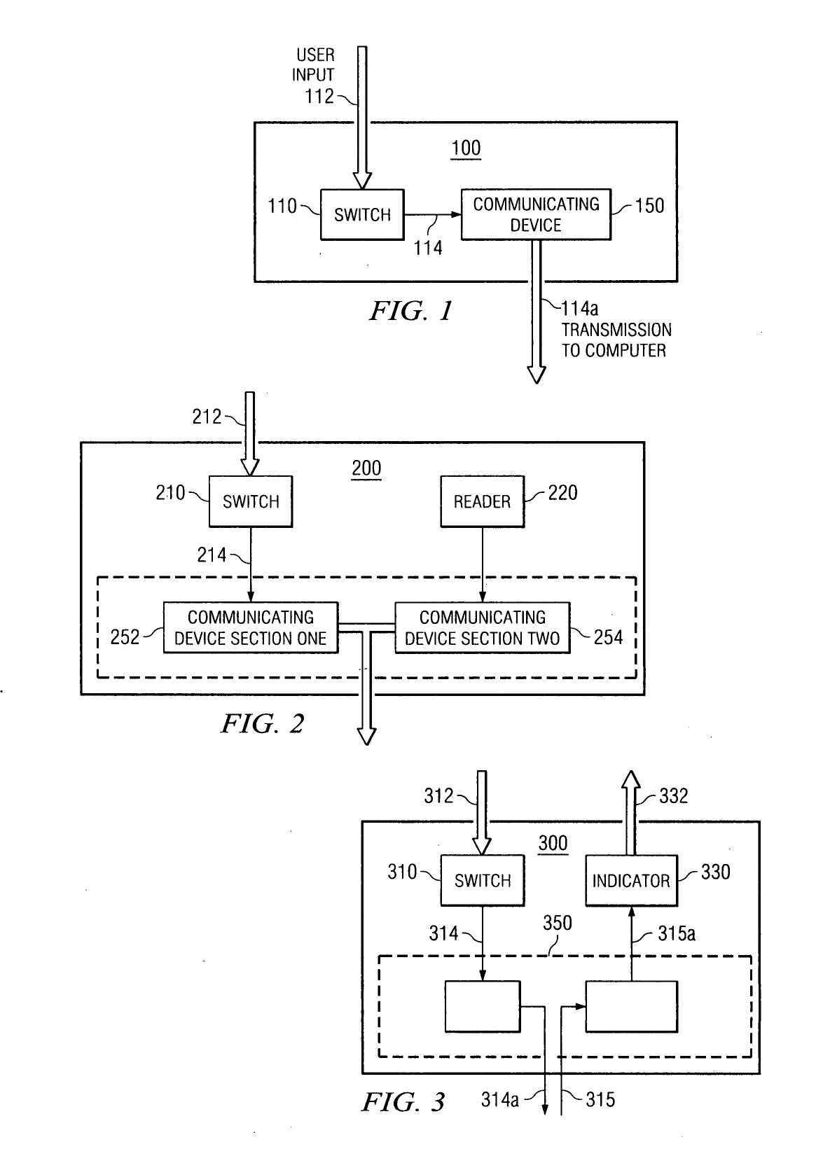

FIG. 1 shows, in a first embodiment of the invention, a freestanding remote functionality module 100 for a computer, the module comprising a hardware control switch 110 for receiving a user input 112 regarding a desired hardware state of the computer, and a communicating device 150 coupled to the switch 110 to receive a hardware control signal 114 from the switch 110 and transmit said hardware control signal 114a to an interface mounted on the computer to control the hardware of the computer.

FIG. 2 shows a second embodiment of the invention. In the second embodiment, a freestanding remote functionality module 200 for a computer is provided. The module 200 comprises at least one mass data storage reader 220, coupled to read computer readable data from mass data storage units, at least one hardware control switch 210 to receive a user input 212 from a user of the computer, a first communicating device section 252 to transmit a hardware control signal 214 received from the switch to an interface to control the operation of hardware of the computer, and a second communicating device section 254 coupled to the at least one mass data storage reader 220 to transmit data read from the mass data storage reader 220 to the computer.

FIG. 3 shows a third embodiment of the invention. A freestanding remote functionality module 300 for a computer is provided. The module 300 comprises a hardware control switch 310 coupled to receive a user input 312 from a user of the computer, the user input 312 relating to control of a hardware operating state of the computer normally controlled by a user control on the computer itself, at least one indicator 330, provided to indicate 332 the state of at least one operating function of the computer, at least one communicating device 350 coupled to the hardware control switch 310 to receive a hardware control signal 314 from the switch 310 and transmit the signal 314a to an interface the computer to control an operating parameter thereof, and coupled to the indicator 330 to receive one or more signals 315 representative of at least one operating parameter of the computer and output the one or more signals 315a to the at least one indicator.

In a form of the first, second and third embodiments, the hardware control switch is a user operable power control switch, which receives a user input relating to a desired power state of the computer and outputs a power control signal to the communicating device, which transmits that signal to the interface, which in turn controls the computer based on the user defined desired power state.

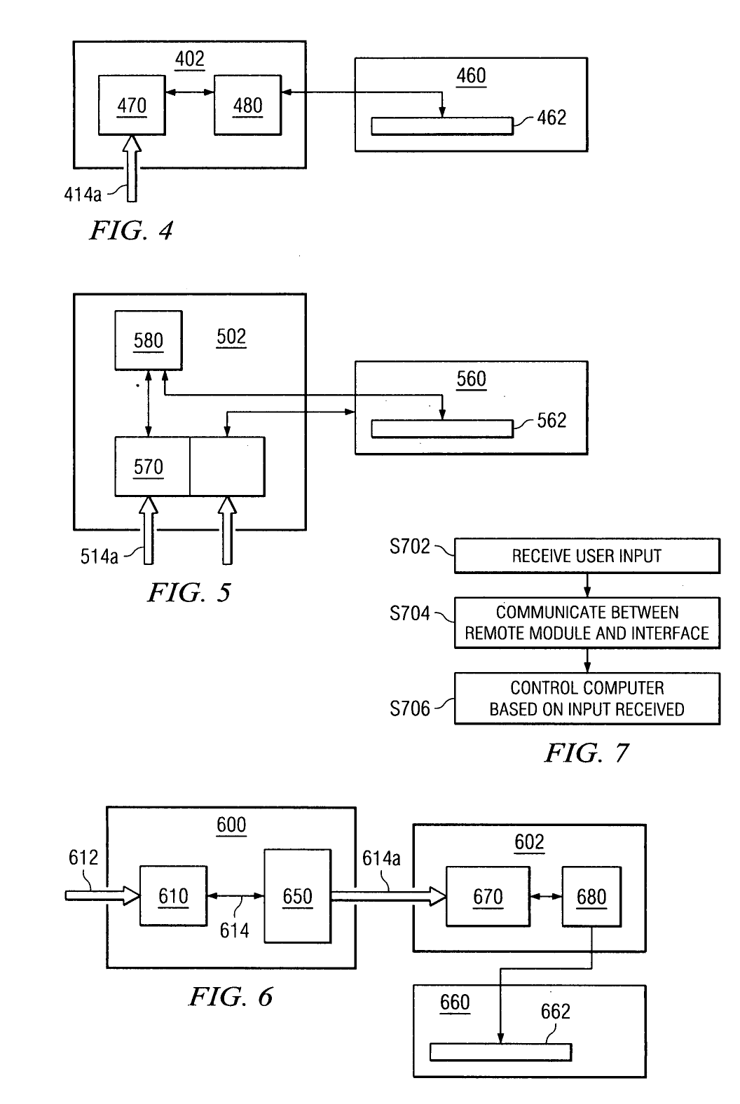

FIG. 4 shows an interface 402 for connection of a computer 460 with a freestanding remote functionality module for the computer 460 according to an embodiment of the invention. The interface 402 comprises an interface communicating device 470 for receiving non-computer code signals 414a received relating to a user input to control the hardware state of the computer 460, and a hardware controller 480 coupled to the interface communicating device 470, adapted to directly connect to a motherboard 462 of the computer 460, and to control the hardware state of the computer 460 directly through the motherboard 462 in response to the received user input signals 414a.

FIG. 5 shows an alternative interface 502 for connection of a computer 560 with a freestanding remote functionality module for the computer 560, according to a further embodiment of the invention. The interface 502 comprises an interface communicating device 570 to be coupled to the computer 560, and adapted to receive computer readable data from the remote module and provide the computer readable data to the computer 560, and to receive signals 514a relating to a user input to control a hardware state of the computer 560, and a hardware controller 580 coupled to the interface communicating device 570 and adapted to directly connect to a motherboard 562 of the computer 560 and control the hardware state of the computer 560 directly through the motherboard 562 in response to the received user input signals.

FIG. 6 shows a yet further alternative embodiment of the invention, and shows a remote computer control system. The system comprises a freestanding remote functionality module 600 for a computer 660, the module 600 comprising a remote user operable hardware control switch 610 configured to receive a user input 612 relating to a desired hardware state of the computer from a user of the computer 660, the user input 612 relating to control of the hardware of the computer 660 normally controlled by a user control device on the computer itself, and a communicating device 650 coupled to the switch 610 to receive non-computer code hardware control signals 614 from the switch and transmit said hardware control signals 614a to an interface at the computer 660 to control the hardware of the computer 660, and further comprising an interface 602 adapted to connect the computer 660 with the freestanding remote functionality module 600 of the computer 660. The interface 602 comprises an interface communicating device 670 adapted to receive non-computer code signals 614a received relating to the user input 612 to control a hardware state of the computer 660, and a power controller 680 coupled to the communicating device 670 adapted to directly connect to a motherboard 662 of the computer 660 and control the hardware state of the computer 660 directly through the motherboard 662 in response to the received signals.

FIG. 7 shows a flow diagram for a method of remotely controlling a computer according to an embodiment of the invention. The method comprises receiving a user input on a freestanding remote functionality module remote from the computer S702, the user input representing a desired hardware state of the computer, communicating the desired computer hardware state to an interface mounted on the computer S704, and controlling contacts provided on a motherboard of the computer directly, dependent on the desired hardware state of the computer S706.

In forms of the fourth and fifth embodiments, the hardware control signal is a power control signal, and the motherboard can be controlled to control the power state of the computer depending on the desired power state. The control in this case is direct to pair of power contacts provided on the motherboard, which must be connected in order for any power to be supplied to the motherboard. In this way, a hard, or cold boot of the computer can be effected, even though no power is being provided to the motherboard, as neither the motherboard nor any other part of the computer needs to receive power to recognise the boot signal and start up the computer. In an alternative embodiment, the interface is incorporated into the motherboard itself. In this case, the contacts may be a part of the interface.

Further, in forms of the sixth and seventh embodiments, the hardware control switch is a user operable power control switch, which receives a user input relating to a desired power state of the computer and outputs a power control signal to the transmitter, which transmits that signal to the interface, which in turn controls the computer based on the user defined desired power state.

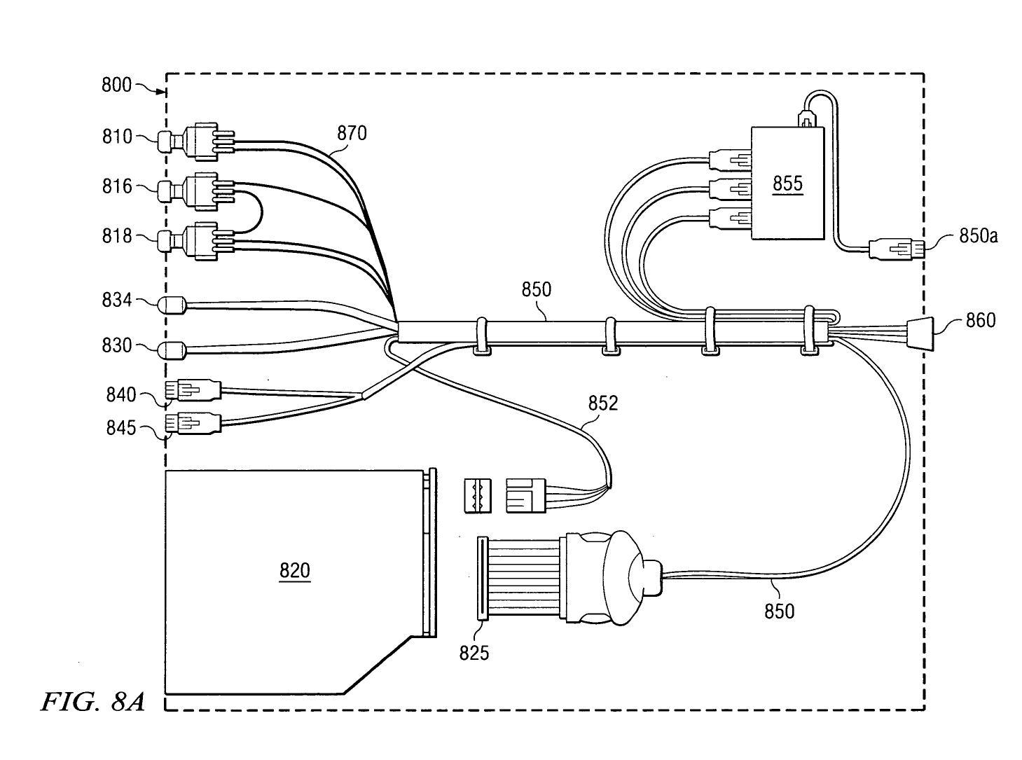

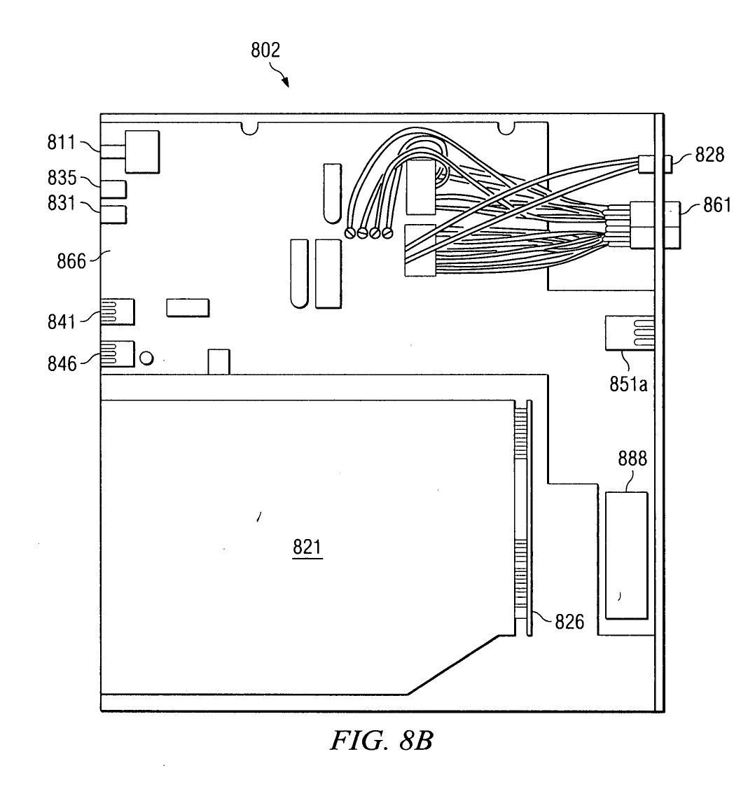

FIG. 8A shows a further embodiment of a freestanding remote functionality module 800 for a computer. The module 800 includes a user operable remote power control switch 810. The power control switch 810 is connected to a communicating means in the form of electrically conducting cables 850 by cables 870. The switch 810 may be any type of switch, such as a latching push to make switch, or a flipflop, rocker or other switching device as is known in the art. Two further switches 816 and 818 are also provided. These switches 816 and 818 do not latch, but revert to the open state when released by a user. In the present embodiment, the further switches 816 and 818 are also connected to the cables 850.

An indicating means 830, in the form of an LED is also provided, which is connected to the communicating means, in this case, a different set of wires within the cables 850. Further, a second indicating means 834, also in the form of an LED, is also provided. Instead of LEDs, other light emitting devices could be provided, such as incandescent bulbs or the like. Further, the indicating means 830 and 834 need not be light-emitting means at all, but could be sound indicators, or could be physically moving parts, which move into different positions in order to provide an indication of the signals received. LCD and plasma displays may also serve to display information in other embodiments.

A mass data storage reading means, in the form of a CD/DVD drive 820, is also provided. The CD/DVD drive is also connected to the communication means (cables 850). The CD/DVD drive is connected to the cables via a converter 825. The converter 825 converts the output of the mass data storage reading means from the internal format used therein (in the present embodiment, IDE, although it might also be IETA format) and to an external format (in the present embodiment, USB). Power is provided to the drive 820 via a further cable 852 and in turn from the computer.

Two USB slots 840 and 845 are also provided in the module, for receiving USB supported devices. In addition to those shown herein, further types of readers and devices may be provided, including smart card readers, compact card readers for storage cards such as compact flash and SD cards etc. Further, other optical mass data storage readers such as blu-ray DVD and HDDVD readers may be provided. Other proprietary slots such as that for IPOD (RTM) may also be provided. Further, firewire (RTM), skype (RTM) and audio in/out connectors may be provided, and connected to a communicating device according to embodiments of the invention. Further, through the USB slots or otherwise, keyboards, mice and other peripheral devices can be connected to the module 800 and in turn to the computer. In alternative embodiments, the freestanding module may also include the keyboard for the computer, or may include other peripheral device or devices. The USB slots are connected to a hub 855 via the cables 850, which hub 855 then outputs to a single USB port 850a. The hub 855 of the present embodiment receives three USB connections and outputs a single USB connection. However, other permutations, such as 7-1, or 10-2 etc, may also be utilized as required. Interface port 860 through the use of a connecting cable connects module 800 to interface 902 at module port 960.

FIG. 8B shows an alternative embodiment of a module, module 802, where power switch 811, indicators 831 and 835, USB slots 841 and 846, and USB port 851a are provided on a single integrated circuit board 866, for ease of manufacture. Additionally, CD/DVD drive 821 is connected to IDE to USB converter 826. IDE to USB converter 826 is incorporated into integrated circuit board 866. Powered USB hub 888 relays signals from CD/DVD drive 821 and USB slots 841 and 846. Powered USB hub 888 is incorporated into integrated circuit board 866. Interface port 861 provides a connection point for module 802 to connect to an interface. Power out connecter 828 functions to supply voltage to a sound system, cooling system, or other optional equipment not shown. The connecting means between the components of module 802 are embedded in the circuit board.

Instead of, or in addition to, electrically conducting cables, optic fibres may be used as the communication means of embodiments of the present invention, and the appropriate changes to be made to the integers of the module will be appreciated by one skilled in the art.

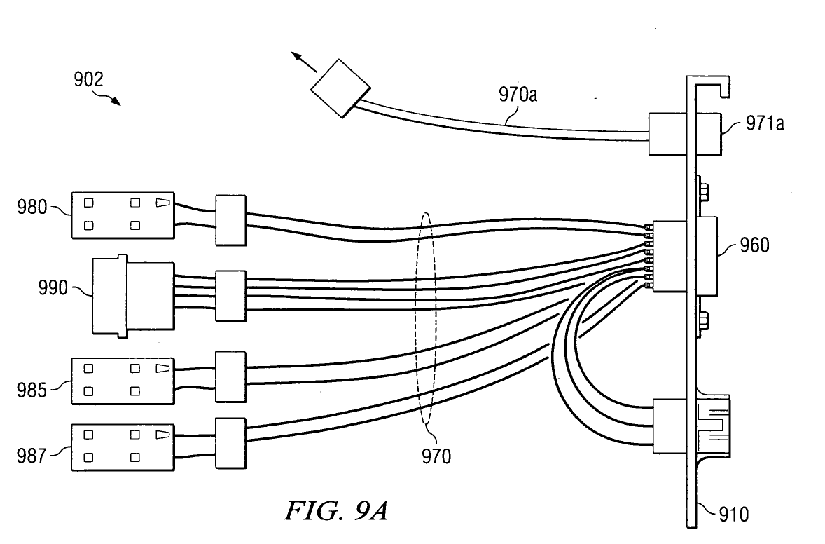

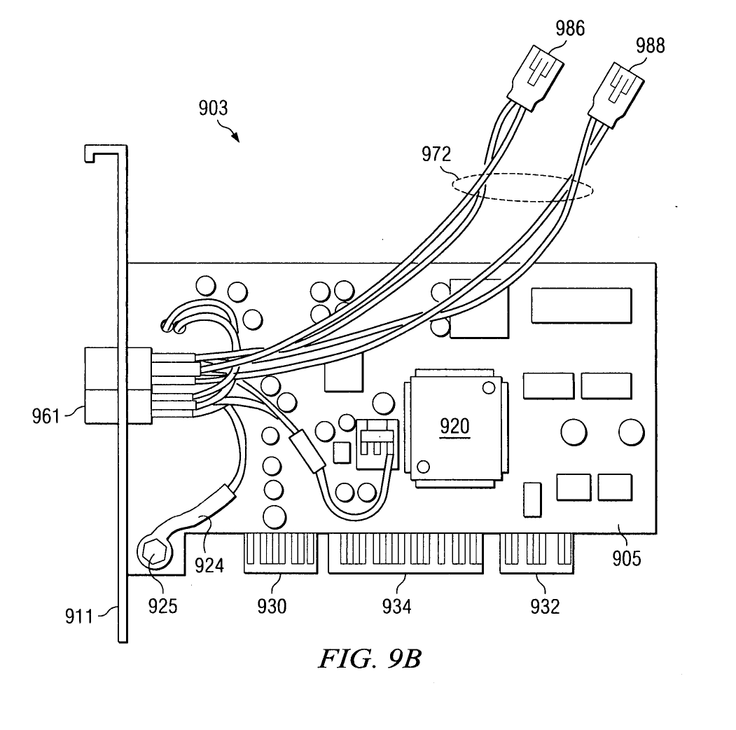

FIG. 9A shows an interface according to an embodiment of the invention. Interface 902 includes metal connector 910 which houses module port 960 and USB port 971a and fits into a standard expansion slot known in the art. Interface 902 further includes a hardware controller in the form of a power control connector 980. The connector power switch is connectable directly to the motherboard of a computer (not shown). The connection is to the two physical pins on the motherboard that must be connected in order for the motherboard to have power. In this way, the hardware controller controls the hardware (in the present embodiment, power state) of the computer directly. As discussed above, in embodiments of the invention, the motherboard does not have to be in a standby state to receive the signal, the computer power off state is not a standby state, but a complete no power state.

The interface also contains interface communication means, which includes a connecting cable 970 connecting to the power control connector 980. The interface also includes a further connecting cable 970a within the interface communication means, which receives computer readable data from the remote module 800 through USB port 971a and provides the computer readable data to the computer. In the present embodiment, this is done by a USB cable 970a, which receives data through USB port 971a connected to USB port 850a of the module of FIG. 8A. The USB cable 970a is connected to a USB port on the computer. This USB port also receives data from the computer and transmits it to the module along cable 970a, through USB port 971a and through USB port 850a.

The interface also includes further cables 970 which receive one or more signals representative of at least one operating state of the computer and transmit the one or more signals to the remote module for output of an indicator signal at the remote module. In the present embodiment, the signals are received from connectors 985, 987, which connect to LED outputs in the computer. The signals, in the present embodiment, relate to the power state of the computer, and to an operating state of the computer, in the form of the activity of a hard disc drive provided within the computer.

Further a power output connector 990 is provided, which provides a power supply to the module, in order to power the reader (CD/DVD drive 820).

The embodiments of FIGS. 8A and 9A can be connected by further cables, which may be considered either extensions of the interface connection means in FIG. 9A or the communication means 850 of FIG. 8A. These extend from the module 800 at interface port 860 and to the interface 902 at module port 960 to connect the module 800 with the interface 902. They may be so connected, and the interface may be connected to the motherboard of a computer. The operation of a remote computer control system according to an embodiment of the invention functions in the following manner.

A user of the system can control the power state (i.e. whether the computer is turned on or off) of the computer remotely by pressing power switch 810. The signal passes along the cable 870 and connecting cables 850 through interface port 860 and module port 960 to the cable 970 of the interface 902. From there, the signal passes to the power control connector 980 mounted on the two pins of the motherboard that must be connected in order for power to be provided to the motherboard. In the present embodiment, the cables 870, 850 and 970 connecting the power switch 810 to the power control connector 980 is a simple circuit, with the module power switch 810 making the contact between the two contact pins on the motherboard, between which electrical contact must be made for any power to be provided to the motherboard.

A user of the system can also access data via the computer using the drive 820 of the module 800. The USB cable 970a sends a control signal to control the drive 820 to read a particular part of a storage medium therein. The data is read by the drive 820 and provided, along cable 850 via hub 855 through USB ports 850a and 971a along cable 970a and to a USB port on the computer.

Further, the module provides an indication of the power state of the computer, and the current hard drive activity by displaying indicators on the LEDs 830 and 834. The signals for these indicator lights 830 and 834 are received by the connectors 985 and 987 and pass, via the cables 970 and 850, from the interface 902 to the module 800. The signals carried on the cables are then output by the LEDs 830 and 834. In a similar way to the power control, a circuit is formed between each of the connectors 985 and 987 and the LEDs 830 and 834 and supply of an electrical current through the cables 850 and 970 causes the LEDs 830 and 834 to illuminate.

Further, the two switches 816 and 818 provided on the module can be used to control non-computer related devices. In one embodiment, the two switches control the height of a desk on which the computer is mounted (one switch raising the desk, the other lowering it). Further, the switches 816 and 818 may control the angle of a monitor attached to the computer or may control any other device as required. Further switches may be provided as desired.

By use of such a system, external operating controls and inputs of a computer can be recreated remotely therefrom. Once this has been done, the computer can be placed in a secure area. The area can be remote from the location at which the user of the computer works, and can be hidden from sight. This is because the computer itself will not need to be accessed during use, either to input media to be read by the computer, or to turn the computer on, or to connect devices to the computer; all of these functions can be carried out by the module.

FIG. 9B shows an alternative embodiment of an interface. Interface 903 is mounted on peripheral component interconnect (PCI) card 905. PCI card 905 incorporates the number of internal wires and connections to the motherboard of interface 902 onto a rigid card that is more durable and easier to connect to the computer. Metal connector 911 houses module port 961 and fits into a standard expansion slot. Cables 972 receive one or more signals representative of at least one operating state of the computer and transmit the signals to the remote module for output of an indicator signal at the remote module. The signals are received from connectors 986 and 988 which are connected to LED outputs of the computer. Embedded on PCI card 905 is chip 920 to provide headphone/microphone connectivity to the module. Ground wire 924 extends from module port 961 and is affixed to PCI card 905 with a screw at 925. 12V power connector 930, data connector 934, and 5V power connector 932 extend laterally on blades of a peripheral component interconnect buss from PCI card 905 to connect directly to the motherboard of the computer.

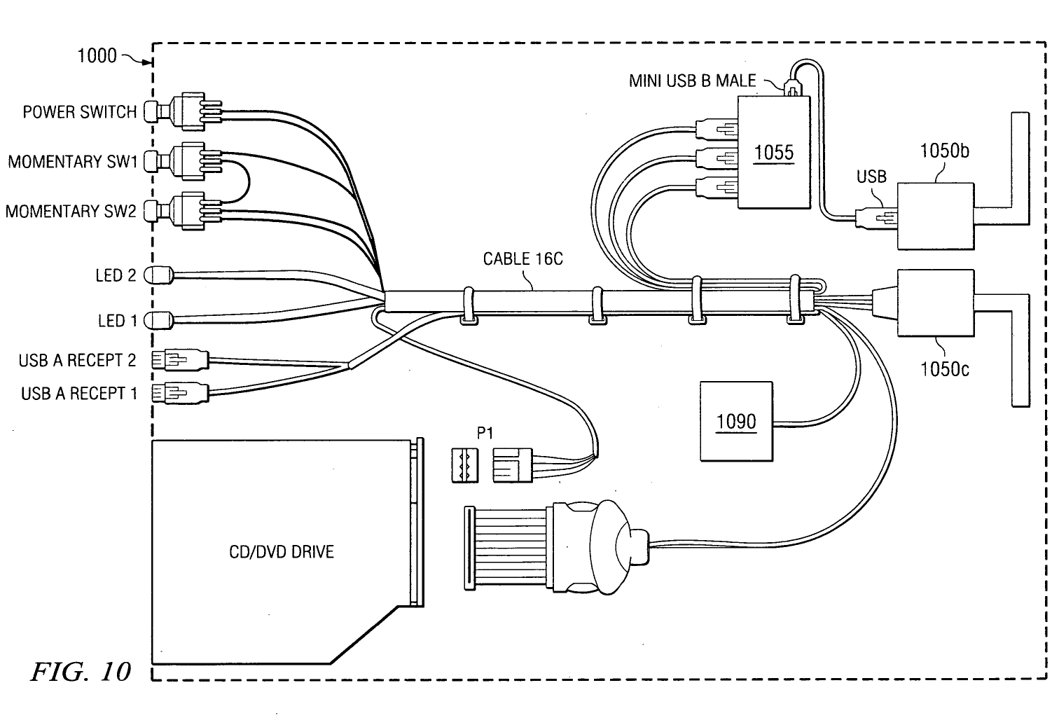

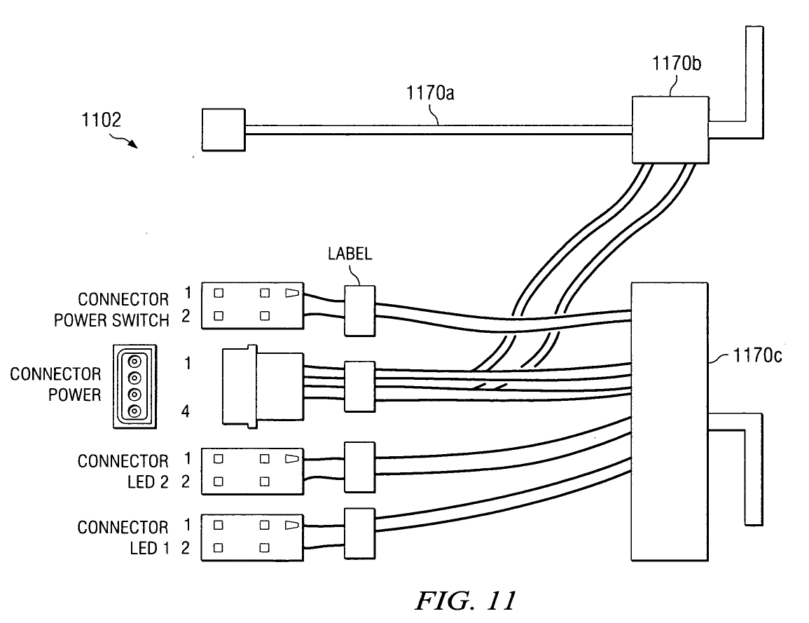

In further alternative embodiments, a wireless connection is provided between the module and the interface. Embodiments of a module and of an interface making use of wireless communication are shown in FIGS. 10 and 11 respectively.

FIG. 10 shows a wirelessly connected module 1000. In the module 1000, an ultra-wide two-way USB wireless connection 1050b is provided, as part of the communication means. A converter to convert the USB format received from the USB hub 1055 to ultra-wide USB format is provided as a part of the wireless connection 1050b.

Further, a standard RF transmitter/receiver pair 1050c is provided. The transmitter/receiver 1050c is also a part of the communication means, and receives the signals from the power switch via the cable. It then transmits the signal to a receiver within the interface, described in more detail below. Further, the transmitter/receiver 1050c receives signals from a transmitter in the interface relating to an operating state of the computer. These signals are outputted from the transmitter receiver 1050c to the module functions without a wire connecting it to the interface. The transmitter/receiver 1050c may be a single device, or may be two individual devices, as required.

In the present embodiment, a power supply 1090 is provided to power the transmitter/receiver 1050c and ultra-wide USB device 1050b. It is also used to power the reader. The other features of the module 1000 are as described above in relation to FIGS. 8A and 8B.

FIG. 11 shows an interface 1102 for use with the module of FIG. 10. The interface 1102 connecting means includes an ultra-wide two-way USB wireless connection 1170b is provided, as part of the interface communication means. The interface also includes a further connecting cable 1170a within the interface communication means, which receives computer readable data from the remote module. A converter to convert the USB format received from the computer to ultra-wide USB format, and vice-versa, is provided as a part of the wireless connection 1170b.

Further, a standard RF transmitter/receiver pair 1170c is provided. The interface transmitter/receiver 1170c is also a part of the interface communication means, and receives the signals from the connectors via the cable, which are as described above in relation to FIG. 9A. It then transmits the signal to the transmitter/receiver 1050c within the module 1000, described above with reference to FIG. 10. Further, the interface transmitter/receiver 1170c receives signals from the transmitter in the module relating to a desired power state of the computer. These signals are outputted from the transmitter/receiver 1170c to the connector power control without a wire connecting it to the module. The transmitter/receiver 1170c may be a single device, or may be two individual devices, as required.

In this embodiment, the power connector of the interface is used to power the transmitter/receiver pair 1170c and ultra-wide USB 1170b, rather than provide power to the module. The other features of the interface 1102 are as described above in relation to FIGS. 9A and 9B.

In alternative embodiments of the invention, both wired and wireless, the module includes the computer keyboard, and/or other peripheral devices. The module may include an integrated pointing device, for controlling the position of a cursor on the screen of the computer. Such peripheral devices may send control signals to the computer via the communication means provided in the module to the interface communication means provided in the interface

In embodiments of the invention, the module removes the need for a user to interact directly with the main the computer itself, i.e. the base unit; the module is the only device that a user needs to interact with when using the computer, from before the computer is turned on, until after it is switched off, and it can be moved around with the user.

In further embodiments of the invention, the module may include the monitor of the computer. In such an embodiment, the interface may include a further connector for connecting with a graphics card in the computer. Alternatively, the connector may connect with an integrated graphics card on the motherboard. The connector receives graphics control signals and outputs them to the interface communication means, which transmits the graphics signals to the communication means in the module. The communication means then passes the graphics signals to the monitor for output on the screen. In one embodiment, the interface and module communication means include a further cable to transmit the graphics signals to the module from the graphic card. In such embodiments, the module may be mounted on a wall or otherwise, so that the monitor is not placed on a surface.

The present invention has been described herein purely by way of example and various omissions, modifications and/or additions will present themselves to those skilled in the art, these omissions, modifications and/or additions falling within the scope and spirit of the invention.

The invention has been described with the aid of functional building blocks and method steps illustrating the performance of specified functions and relationships thereof. The boundaries of these functional building blocks and method steps have been arbitrarily defined herein for the convenience of the description. Alternate boundaries can be defined so long as the specified functions and relationships thereof are appropriately performed. Any such alternate boundaries are thus within the scope and spirit of the claimed invention.

Any discussion of the prior art throughout the specification is not an admission that such prior art is widely known or forms part of the common general knowledge in the field.

Unless the context clearly requires otherwise, the words “comprise”, “comprises”, “comprising” and the like are to be interpreted in an inclusive, rather than exclusive or exhaustive, sense; that is it say, in the sense of “including but not limited to”.

1. A freestanding remote computer functionality module for the module comprising:
a mass data storage reader to read a set of computer readable data from a mass data storage media of a computer;
a user operable hardware control switch, configured to receive a user input regarding a desired state of the computer and output a signal;
a first communicating device section, coupled to the hardware control switch, to transmit the signal to an interface to control a power state of the computer; and
a second communicating device section, coupled to the mass data storage reader, to transmit the set of computer readable data to the computer.

2. The freestanding remote computer functionality module according to claim 1 further comprising:
a first USB slot connected to the first communicating device section and further connected to a hub;
a second USB slot connected to the first communicating device section and further connected to the hub;
a first indicator connected to the first communicating device section;
a second indicator connected to the first communicating device section; and
wherein the at least one mass data storage reader, the user operable hardware controller switch, the first communicating device section, the second communicating device section, the first USB slot, the second USB slot, the first indicator, and the second indicator are provided on a single integrated circuit board.

3. The freestanding remote computer functionality module according to claim 1, further comprising:
an indicator to indicate an operating state of the computer; and
a receiver, coupled to the indicator, to receive one or more signals representative of an operating state of the computer from the computer, and output a signal to the indicator to control the indicator to indicate the operating state of the computer.

4. A freestanding remote computer functionality module, the module comprising:
a user operable power control switch configured to receive power control input from a user of the computer;
an indicator for indication of an operating state of the computer;
a communicating device, coupled to the user operable power control switch, to receive a signal from the user operable power control switch and transmit the signal to the computer to control a power state of the computer, and coupled to the indicator to receive a signal representative an operating parameter of the computer and to output the signal to the indicator.

5. The freestanding remote computer functionality module according to claim 4, further comprising:
a mass data storage reader, to read a set of computer readable data from a mass data storage device;
a two-way communicating device, coupled to the mass data storage reader, to transmit the set of computer readable data to the computer, and to receive data from the computer to be written to the mass data storage device, wherein the mass data storage reader is also a data writer to write the data to be written to the mass data storage device received by the two-way communicating device.

6. The freestanding remote computer functionality module according to claim 1, wherein the two-way communicating device comprises a wireless communicating device.

7. The freestanding remote computer functionality module according to claim 6, wherein the wireless communicating device comprises ultra-wide USB.

8. The freestanding remote computer functionality module according to claim 1, wherein the hardware control switch generates a non-computer code signal, suitable to control the power state of the computer directly through a set of power contacts on a motherboard of the computer, based on a user input and the second communicating device section is coupled to the hardware control switch to receive the non-computer code signal from the hardware control switch and transmit the non-computer code signal to an interface mounted on the computer to control the power state of the computer.

9. The freestanding remote computer functionality module according to claim 8, wherein the hardware control switch is arranged to transmit a set of control instructions to control the power state of the computer directly to the motherboard of the computer.

10. An interface for connection of a computer with a freestanding remote functionality module of the computer, the interface comprising:
an interface communicating device, coupled to the computer, for receiving computer readable data from the remote functionality module and for providing the computer readable data to the computer, and for receiving a set of user input signals from a remote user operable switch to control a power state of the computer; and
a power controller, coupled to the interface communicating device for connecting to a motherboard of the computer and controlling a power state of the computer directly through the motherboard in response to the set of user input signals.

11. An interface according to claim 10, wherein the interface communicating device and the power controller are mounted to a PCI card.

12. An interface according to claim 10, wherein the interface communicating device is adapted to receive a set of signals representative of an operating state of the computer and transmit the one or more signals to the remote module.

13. An interface according to claim 10, wherein the interface communicating device is further adapted to receive computer readable data from the computer and transmit the data to the freestanding remote computer functionality module.

14. An interface according to claim 10, wherein the interface communicating device is adapted to transmit and receive wirelessly.

15. A method of remotely controlling a computer, comprising:
receiving a user input on a user operable switch mounted in a freestanding remote functionality module remote from the computer, the user input representing a desired power state of the computer;
communicating the desired computer power state to an interface mounted on the computer; and
controlling a set of power contacts on a motherboard of the computer through the interface, dependent on the desired power state of the computer.

16. A method according to claim 15, further comprising:
reading a set of computer readable data from a mass data storage reading device mounted in the functionality module;
communicating the set of computer readable data from the functionality module to the interface; and
outputting the set of computer readable data to the computer.

17. A method according to claim 15, further comprising:
receiving, at the interface, a set of signals representing an operating state of the computer from the computer;
transmitting the set of signals from the interface to the functionality module;
receiving the set of signals at the functionality module; and
outputting an indication signal of the desired power state of the computer based on the set of signals.

18. A freestanding remote computer functionality module connected to a computer, the functionality module comprising:
a mass data storage reader mounted in the functionality module;
a first wireless communicating device section, mounted in the functionality module and coupled to the mass data storage reader, to transmit data read from the mass data storage reader from the functionality module to the computer;
a remote power control switch;
a remote power indicator;
a second wireless communicating device, mounted in the functionality module, coupled to the remote power control switch and remote power indicator, to transmit instructions to the computer to control a motherboard of the computer directly based on user activation of the remote power control switch and to receive signals from the computer indicative of a power state of the computer.

19. The freestanding remote computer functionality module according to claim 18, wherein the mass data storage reader is a ROM reader and a converter is provided coupled between the mass data storage reader and a wireless transmitter to convert a data stream from the mass data storage reader from an internal format to an external format to be transmitted by the wireless transmitter.

20. A remote computer control system, comprising:
a freestanding remote computer functionality module and an interface for connecting a computer with the freestanding remote functionality module, the freestanding remote computer functionality module comprising:
a user operable power control switch configured to receive a user input regarding a desired power state of the computer and output a non-computer code signal;
a power indicator; and
a communicating device coupled to the user operable power control switch to receive the non-computer code signal and transmit the non-computer code signal to an interface mounted to the computer to control the desired power state of the computer, and coupled to the power indicator, to receive an indicator signal from the interface and control the power indicator based on the indicator signal, the interface comprising:
an interface communicating device for receiving the non-computer code signal and for receiving the indicator signal and for transmitting the indicator signal to the freestanding remote computer functionality module; and
a power controller coupled to the communicating device, connected with a motherboard of the computer, for controlling the desired power state of the computer through the motherboard in response to the non-computer code signal.
